(19) United States
(12) Patent Application Publication
(10) Pub. No.: US 2019/0147390 A1
(43) Pub. Date: May 16, 2019

(54) PREDICTING TIMELY COMPLETION OF A WORK ORDER

(71) Applicant: Telefonaktiebolaget LM Ericsson (publ), Stockholm (SE)

(72) Inventors: Shivashankar SUBRAMANIAN, Chennai (IN); Kalyana Chakravarthy BEDHU, Bellevue, WA (US); Saradindu KAR, Odisha (IN); Sujoy ROYCHOWDHURY, Bangalore (IN); Abhishek SARKAR, Bengaluru (IN)

(73) Assignee: Telefonaktiebolaget LM Ericsson (publ), Stockholm (SE)

(21) Appl. No.: 16/095,144

(22) PCT Filed: Apr. 21, 2016
(86) PCT No.: PCT/IN2016/050115

§ 371 Date: Oct. 19, 2018

(51) Int. Cl. G06Q 10/06

(52) U.S. Cl. CPC G06Q 10/063116; G06Q 10/0633

(57) ABSTRACT

The present disclosure relates to a method performed by a processing device (4) of a Work Force Management (WFM) system (1) for predicting timely completion of a work order for service at a remote site (3) of a telecommunication system (2). The method comprises obtaining information about a time period allowed for completion of the work order. The method also comprises selecting, based on previous knowledge about the remote site, a set of factors which may affect service at the remote site. The method also comprises updating information about the selected factors. The method also comprises, at a first point in time within the allowed time period, obtaining information about a current status of the work order. The method also comprises, based on the updated information and the work order status at said first point of time, predicting whether it is likely that the work order will be completed within the allowed time period. The method also comprises, at a second point in time within the allowed time period, obtaining information about a current status of the work order. The method also comprises, based on the work order status at said second point of time, predicting that it is not likely that the work order will be completed within the allowed time period. The method also comprises outputting a warning for an operator (6) of the WFM system that the work order will likely not be completed within the allowed time period unless an additional action is taken.

### TECHNICAL FIELD

The present disclosure relates to a method and a device for predicting timely completion of a work order for service at a remote site of a telecommunication system.

### BACKGROUND

Many requests for service on a telecommunication network need to be completed within a contractual time period called Service Level Agreement (SLA). Most service contracts have a stipulated financial penalty for not being able to meet the SLA. Additionally, there is a direct effect on customer experience which may not be easily financially quantifiable.

It is therefore important that those service requests which are likely to breach SLA are flagged as soon as possible so that the operations team can look into it and take action before SLA is breached.

In a special case, a part of a service contract involves sending out dispatch engineers to site to fix problems on network equipment. Most of these problems affect the cellular or fixed line networks and thus impact the end consumer—either in complete network unavailability or poorer performance. The field engineer dispatch is managed via a tool called Workforce Management (WFM) and the service request is called a Work Order.

Services in general are discussed in various domains such as retail, cloud, etc. In Software-as-a-Service (SaaS) model, s service is described as a coarse-grained value added service which is a composition of existing web services. Whereas in Service-Oriented computing, distributed service-based applications are designed with loosely-coupled specialized component services to give more control to third parties for cross-organizational tasks. Similarly, cloud services are defined on cloud infrastructure to comply with user requirements and provide minimal user interaction with computing environment. SLA is common to all kinds of above mentioned managed services. SLA is binding for each service to be deployed and managed for a specific business need.

SLA Breach prediction is important to ensure that work orders are flagged as likely to breach as soon as possible so that appropriate action can be taken on them to prevent the SLA breach and avoid financial penalty as well as provide better customer experience. A work order often has some type of ticket attached and is an order received by a managed services unit/department from a customer/client. It can also be an order created internally within the department. A work order may be a request for products or services.

SLA breach prediction is currently done in many domains using static business rules defined by subject matter experts, which are used to set flags for SLA breach. Current methods consider predefined Service Level Objectives (SLOs) and predict for services. Predictions are based on checkpoints in the life-cycle of a work order. Typically, work orders are flagged too late in order to take action to prevent SLA breach.

### SUMMARY

It is currently not possible to understand the impact of each of the sources on SLA breach prediction task, for example spare parts management, traffic/weather conditions, engineers' skill management, equipment inventory details, etc., which can be cascaded for process improvement w.r.t those sources. For instance, if we can interpret that we spend unusual time in certain life-cycle states, say, in-cases when assigning certain engineers to fix equipment from certain vendors; this can be used as a feedback to improve the training process.

In telecommunication, the work-order may have a life-cycle which is a composite of services. Each service would be influenced by various factors, from different data/information sources. For instance, time taken to assign an engineer could be associated with efficiency of field management unit. The time taken to fix the problem could be attributed to field engineer’ skill. The travel time to a remote site could be attributed to either field management unit (allocation strategy) or other factors such as traffic conditions or weather. Similarly, each of the work-order specific factors that can be used for classification might be associated with one or more sources of information.

In the existing techniques, it is not possible to understand the influence of each factor on different parts of the composite service. For instance, weather might influence field management more than other parts. Similarly, background details about the remote site (such as whether it is located in a crowded area, inside a school etc.) could influence field management. Since the number of parts of the work order could be many and may be extended over time, it would be convenient with an automated system/method to learn a model with discriminating factors as well as to be able to interpret various factors' influences on the different parts.

Service request data may have multiple sources of information. Each factor has various influences on each of the aspects/service parts based on the task. For example, in a general setting, the factor of “wearing a watch” could have an influence on the aspects “keeping time” and “fashion awareness”. Based on the task of the work order, the factor's influence on each of the aspects could vary. Similarly, a factor “overall latency” with regard to SLA breach prediction could have different influence on various aspects such as efficiency of engineers, spare parts management, traffic conditions, weather conditions and so on. It may be convenient to understand the influence of each of the factors on different aspects of SLA breach prediction. This can help us derive patterns from historic data which can be used to update the static rules as well as re-learn and update them dynamically as required. More importantly, this may also help to understand the influence of factors/patterns on different aspects that can be used for process improvement for those aspects. Herein, a method to handle various sources of information and derive patterns from work order life-cycle data which explains the influence of different factors on SLA breach is proposed.

According to an aspect of the present disclosure, there is provided a method performed by a processing device of a WFM system for predicting timely completion of a work order for service at a remote site of a telecommunication system. The method comprises obtaining information about a time period allowed for completion of the work order. The method also comprises selecting, based on previous knowledge about the remote site, a set of factors which may affect service at the remote site. The method also comprises updating information about the selected factors. The method also comprises, at a first point in time within the allowed time period, obtaining information about a current status of the work order. The method also comprises, based on the updated information and the work order status at said first point of time, predicting whether it is likely that the work order will be completed within the allowed time period. The method also comprises, at a second point in time within the allowed time period, obtaining information about a current status of the work order. The method also comprises, based on the work order status at said second point of time, predicting that it is not likely that the work order will be completed within the allowed time period. The method also comprises outputting a warning for an operator of the WFM system that the work order will likely not be completed within the allowed time period unless an additional action is taken.

According to another aspect of the present disclosure, there is provided a computer program product comprising computer-executable components for causing a processing device to perform an embodiment of the method of the present disclosure when the computer-executable components are run on processor circuitry comprised in the processing device.

According to another aspect of the present disclosure, there is provided a processing device for a WFM system for predicting timely completion of a work order for service at a remote site of a telecommunication system. The processing device comprises processor circuitry, and storage storing instructions executable by said processor circuitry whereby said processing device is operative to obtain information about a time period allowed for completion of the work order. The processing device is also operative to select, based on previous knowledge about the remote site, a set of factors which may affect service at the remote site. The processing device is also operative to update information about the selected factors. The processing device is also operative to, at a first point in time within the allowed time period, obtain information about a current status of the work order. The processing device is also operative to, based on the updated information and the work order status at said first point of time, predict whether it is likely that the work order will be completed within the allowed time period, The processing device is also operative to, at a second point in time within the allowed time period, obtain information about a current status of the work order. The processing device is also operative to, based on the work order status at said second point of time, predict that it is not likely that the work order will be completed within the allowed time period. The processing device is also operative to output a warning for an operator of the WFM system that the work order will likely not be completed within the allowed time period unless an additional action is taken.

According to another aspect of the present disclosure, there is provided a computer program for predicting timely completion of a work order for service at a remote site of a telecommunication system. The computer program comprises computer program code which is able to, when run on processor circuitry of a processing device of a WFM system, cause the processing device to obtain information about a time period allowed for completion of the work order. The code is also able to cause the processing device to select, based on previous knowledge about the remote site, a set of factors which may affect service at the remote site. The code is also able to cause the processing device to update information about the selected factors. The code is also able to cause the processing device to, at a first point in time within the allowed time period, obtain information about a current status of the work order. The code is also able to cause the processing device to, based on the updated information and the work order status at said first point of time, predict whether it is likely that the work order will be completed within the allowed time period, The code is also able to cause the processing device to, at a second point in time within the allowed time period, obtain information about a current status of the work order. The code is also able to cause the processing device to, based on the work order status at said second point of time, predict that it is not likely that the work order will be completed within the allowed time period. The code is also able to cause the processing device to output a warning for an operator of the WFM system that the work order will likely not be completed within the allowed time period unless an additional action is taken.

According to another aspect of the present disclosure, there is provided a computer program product comprising an embodiment of the computer program of the present disclosure and a computer readable means on which the computer program is stored.

Advantages of embodiments of the proposed solution include
i. SLA breach prediction based on different aspects/parts of a work order by dynamically reselecting the factors used.
ii. The factors used may be reselected when the reliability of their data sources change for work orders and over time.
iii. It may be possible to determine the impact of different factors/sources of information on SLA breach using historic work order life-cycle data.
iv. A work order running the risk of an SLA breach may be flagged earlier than when using fixed check points which may not satisfy the time constraints required to prevent breach.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic block diagram of an embodiment of a WFM System and its external interactions in accordance with the present disclosure.

FIG. 2 is a schematic flow chart illustrating an embodiment of changes of the status of a work order over the allowed time period in accordance with the present disclosure.

FIG. 3 is a schematic flow chart illustrating an embodiment of selecting a set of factors which affects the service at a remote site, in accordance with the present disclosure.

FIG. 4a is a schematic block diagram of an embodiment of a processing device in accordance with the present disclosure.

FIG. 4a is a schematic functional block diagram of an embodiment of a processing device in accordance with the present disclosure.

FIG. 5 is a schematic illustration of an embodiment of a computer program product in accordance with the present disclosure.

FIG. 6 is a schematic flow chart of an embodiment of the method of the present disclosure.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

The solution described herein provides a generic framework which may be implemented for any service request model.

The proposed algorithm handles multi-factor information—main and auxiliary factors for SLA breach prediction (and can be extended to other similar applications). For SLA breach prediction is considered, e.g. the work order lifecycle data, Business Intelligence (BI) information, weather data, skill of engineers, site information and inventory information. Lifecycle/BI factors may be main factors using which SLA breach can be predicted. But this would not help to understand the reasons for breach without also considering other auxiliary factors from external information sources. SLA lifecycle data is influenced by other sources of information e.g. from Network Operations Centre (NOC), field engineer & management and the dispatcher. The life cycle factor would contain work order state changes such as unassigned (attributed to field management, dispatcher), assigned (attributed to field management, dispatcher), in progress (attributed to field engineer), request-re-open (attributed to NOC), rejected (attributed to NOC) and so on. With the availability of multiple factors from multiple sources of information, it may be desirable to understand the importance of each of the factors for not only solving the work order task but also interpret the influence of factors on different aspects of the work order that can be used for future improvement of the algorithm.

For a given task SLA breach prediction, data sources/factors may be categorized as internal or external. In this context, internal data sources are near-by data i.e. in direct relation to the main factor (Work order status) and external data sources are defined as data which have no direct relation with main data source, for example in our case e.g. weather data. Additionally we have other auxiliary (internal or external) data sources such as equipment, site information and engineer information for the given work order.

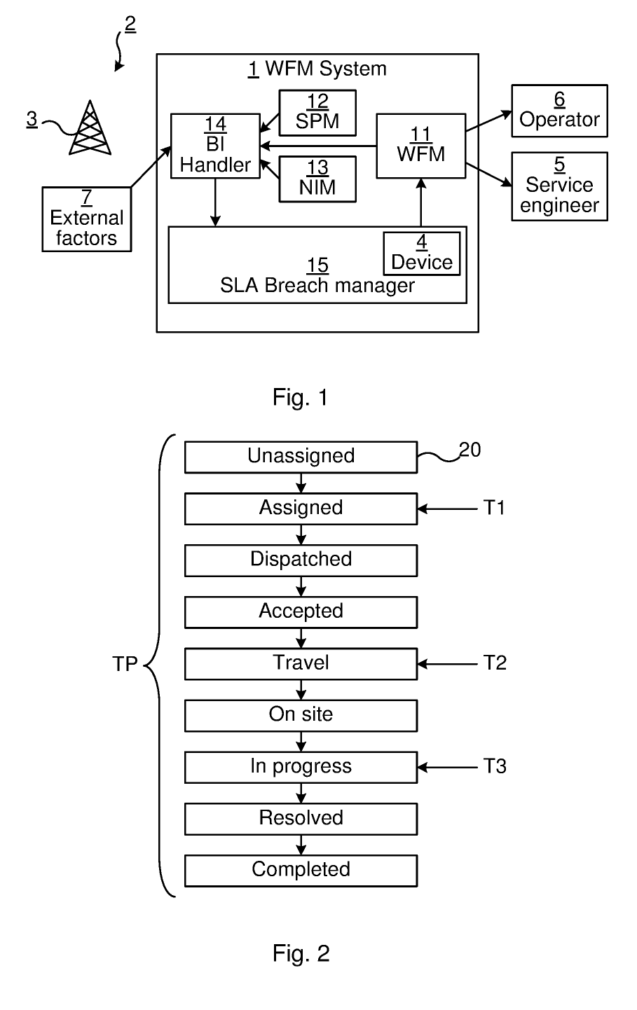

FIG. 1 illustrates an embodiment of a WFM system 1 in which a BI handler 14 receives information about various factors which may influence the timely completion of a work order. The BI handler may e.g. receive factor information from a Spare Part Management (SPM) module 12, a WFM module 11, a Network Inventory Management (NIM) module 13, as well as from external information sources of external factors 7. Data from the BI handler 14 is processed in accordance with the algorithm/method of the present disclosure by the SLA breach manager 15, which outputs information about its SLA breach prediction to the WFM 11. The WFM 11 is in contact with external parties, especially with the service engineers 5 which it may assign the work order and which may perform its service task at the remote site 3 (e.g. an enhanced Node B, eNB) of the telecommunication system 2. The WFM 11, or other part of the WFM system 1, may be in communication with an operator 6 of the WFM system 1 such that the operator may be informed of when a work order is flagged for risk of SLA breach whereby the operator may take additional actions to prevent the breach (e.g. by assigning additional resources, such as service engineers or equipment, to the work order). The processing device 4 which performs the method of the present disclosure may be a separate unit or may be comprised in, or comprise, any of the herein discussed parts of the WFM system 1, e.g. in the SLA breach manager 15 or in the WFM 11, preferably in the SLA breach manager.

FIG. 2 is a flow chart illustrating how a work order 20 may change status during its lifecycle. The status is typically communicated to the SLA manager 15, especially to the processing device 4, e.g. periodically at times T1, T2 and T3 during the time period (TP) allowed for the completion of the work order, as shown in the figure, or in response to each or specific status changes. For example, a work order 20 may pass through the following statuses during its lifecycle:

Unassigned—Not yet assigned to a service engineer 5;
Assigned—Assigned to a service engineer;
Dispatched—Sent to the assigned service engineer;
Accepted—Accepted by the service engineer;
Travel—The service engineer is travelling to the remote site 3;
On site—The service engineer is at the remote site;
In progress—The service engineer is performing service on the remote site;
Resolved—The service engineer has solved the problem (performed the task) of the work order;
Completed—The service is completed and the work order is closed.

For example, the main table of a work order may comprise work order identifier (woid), priority, state, location, engineer assigned, issue raised, and/or SLA label. This represents a life-cycle of the work order. In this case factors are categorical in nature. Factors for a first work order may include BI information (woid, count: no of times state is visited, time spent: time spent in a state, subtype: network issue type, siteid: site specific details, SLA label), which can be mix of both numerical and categorical values of the factors. Similarly, factors for a second work order may be represented as a sequence of discriminative events, for ex: (woid, event1, event2, event3). These events are categorical in nature. For instance resolved or closed, and request in progress or in progress, are discriminative patterns.

Internal information sources: may be auxiliary, such as the source Equipment can have attributes such as (location, region name, network element, network type, description) which may be factors in the present method. Likewise, Site information may have attributes such as (location, location restricted access, location partially banned). These attributes may be binary in nature. Site info has location as common link with work order table. Engineer information may have attributes such as (engineer-id, engineer region: region he belongs to, engineer skill, engineer travel speed: his movement range and speed).

External information Sources: Additionally there may be external information sources such as weather, possible attributes which may be used include (stationed, date, air temperature, cloudiness, humidity). The external sources/factors have no direct relationship with the internal sources. A nearby weather station may be chosen automatically as information source e.g. using K-nearest neighbour (KNN) method. There can be other sources such as traffic of a region, geo-spatial information like latitude, longitude, terrains etc.

For a given scenario, we have additional sources as mentioned above to predict whether the work order (wo) is going to breach or not. In this problem we have labels (wo violated or not) only in the main table. But we do not have labels in auxiliary sources because these sources represent different entity such as engineer, site, and equipment details. However other sources are not independent of each other during the decision making. For example the decision can be interpreted as a work order will breach if it is waiting at external state. Information of external state depends on the equipment details, as the necessary equipment is not available in inventory at that time. Similarly SLA can be breached if the wo spent more time in assigned state. So time for assigning a work order to an engineer depends on the number of available engineers in this region. Furthermore there can be a reason to remain in accepted state, because of necessary skill and expertise to fix the issue raised. Also there is possible reason that the site is not accessible in certain time of the days like during night, weekend, and public holidays. A problem to analyse may be extreme weather condition and uneven terrains, information about which may be accessed from external data sources like weather station and geo-spatial data source. Weather of the region may affect the mobility pattern of engineers in specific times of the year and that may result in pushing a work order to infinite waiting state.

The algorithm of the present method may be updated dynamically by means of Machine Learning (ML). In accordance with the present disclosure, it is possible to consider the dependency between attributes/factors of different information sources, assess the inter-dependency, choose the non-trivial subsets of factors that contribute to predictive capacity of the system and combine the predictions using any function (linear/non-linear). This solution is practically viable because there is no assumption on the domain or data, after generation of subsets the individual factor models can be built in parallel/distributed fashion. So this method may be adapted easily to multi-core/distributed learning paradigms easily.

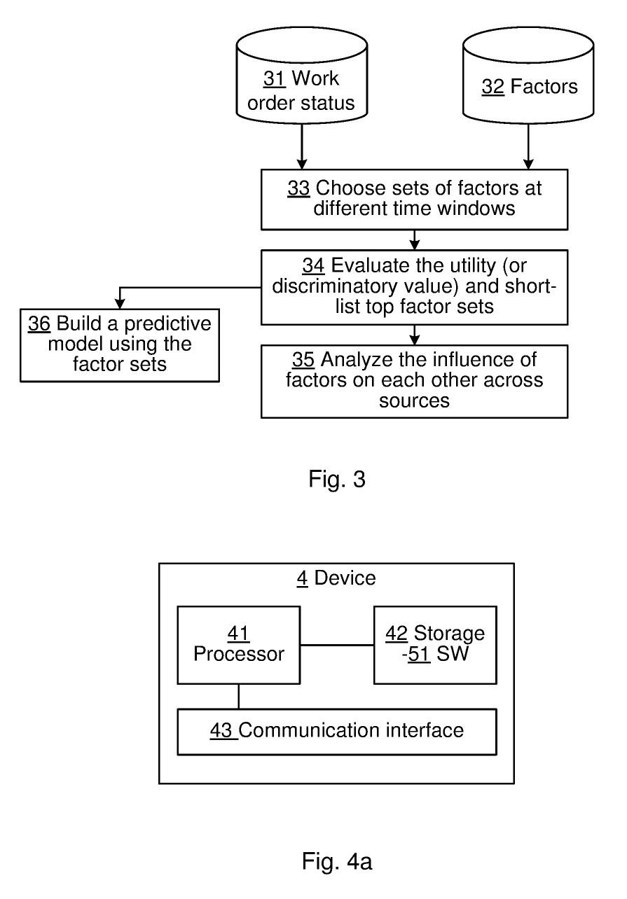

FIG. 3 illustrates an embodiment of a flow chart for selecting the set of factors 32 which will be used to predict whether the work order will be completed in time to avoid an SLA breach.

Input: As mentioned above, there are multiple sources of information possible for SLA breach prediction. Let us consider a case with three sources X(x1 . . . xk), Y (y1 . . . y1), Z (z1 . . . zm), etc. X, Y and Z sources have k, l, and m number of attributes/factors 32 (potential factors to be selected to the set of factors) respectively. The main source being the status 31 of the work order 20.

Output: Set of factors 32 for SLA breach prediction.

### Method:

Step 33—Choose sets of factors at different time windows:

Find sequence of work order lifecycle events that frequently occur within various time intervals. Here frequency threshold and interval has to be empirically determined for the dataset using historical information.
Find sequences from data that happen within a certain interval of time. Use this to build transactions. Here, each audit trail entry is called a transaction (lifecycle data). Whatever frequent sequences are mine are called patterns.
   Compute the frequencies of each of the patterns.
   If the frequency is above a predefined threshold, then add it to the look-up table.
From the lifecycle data a sliding window of patterns is construct over time, e.g. every 15 minutes or 30 minutes.
   This captures what patterns happen in a sequence of time windows, each of which has uniform interval of time.

Step 34—Evaluate the utility (or discriminatory value) and short-list top factor sets:

The utility is the business goal, e.g. to maximize the accuracy for predicting SLA violations within 2 hours. Based on the goal, or utility in hand, the model's parameters are tuned.

Select random subset of attributes R_{N} (say ‘N’) across information sources.

For very window Wi estimate the likelihood using the pattern and R_{N}, where W1, W2, W3 . . . Wn windows are totally possible. ‘n’ is based on maximum possible length of lifecycle, say priority 1 TP is 12 hours, priority 2 is 24 hours, priority 3 is 48 hours and so on. If the window is 30 minutes, then ‘n’ is 24 for priority 1.

P (Breach|pattern, R_{N}, Wi)

Step 35—Analyse the influence of factors on each other across sources:

Probability can be seen as a proxy for confidence or influence of pattern, R_{N} on SLA breach. Repeat the above procedure for a pre-defined number of times, say ‘C’, then removing repetitions. A non-redundant set of pattern, R_{N} that has highest influence on ‘Breach’ are chosen. Also check the independence of Wi and pattern, R_{N}.

Select top ‘K’ combinations of pattern, R_{N}, Wi for further analysis. Influence of attributes across sources can be computed as

Influence (X, Y)=P(X, Y)/P(X), this is influence of X on Y.

Step 36—Build a predictive model using the factor sets:

This factor/attribute analysis can be used for descriptive analytics, or alternatively this input can also be used to build a new machine learning model such as ‘multi-source’ tree, where the pattern, R_{N} pairs are used to grow the tree, and change in information gain can be used to prune the tree.

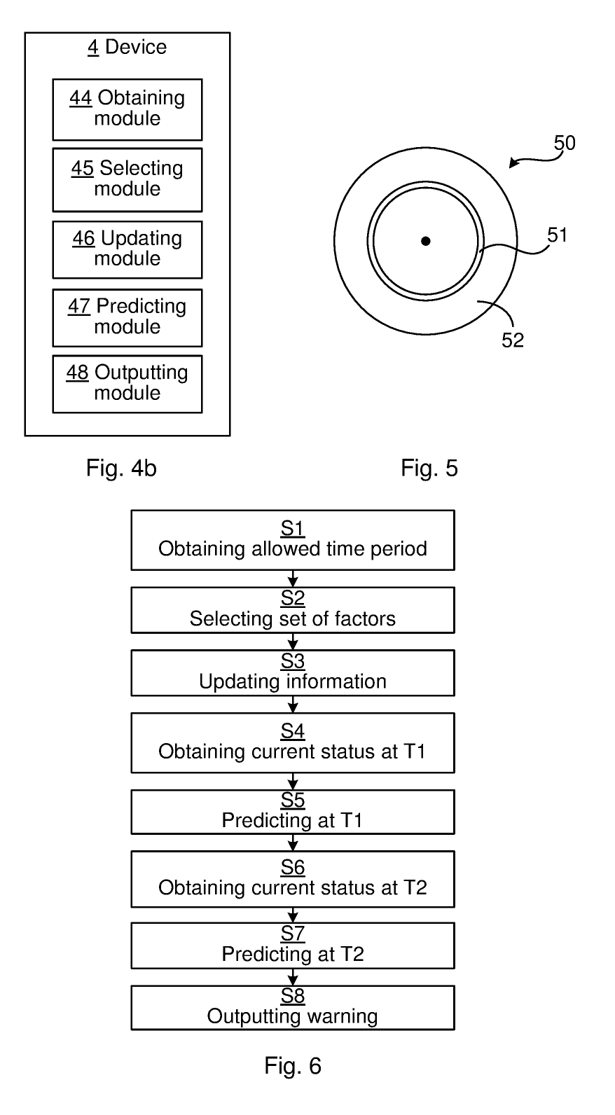

FIG. 4a schematically illustrates an embodiment of a processing device 4 of the present disclosure. The processing device 4 comprises processor circuitry 41 e.g. a central processing unit (CPU). The processor circuitry 41 may comprise one or a plurality of processing units in the form of microprocessor(s). However, other suitable devices with computing capabilities could be comprised in the processor circuitry 41, e.g. an application specific integrated circuit (ASIC), a field programmable gate array (FPGA) or a complex programmable logic device (CPLD). The processor circuitry 41 is configured to run one or several computer program(s) or software (SW) 51 (see also FIG. 5) stored in a storage 42 of one or several storage unit(s) e.g. a memory. The storage unit is regarded as a computer readable means 52 (see FIG. 5) as discussed herein and may e.g. be in the form of a Random Access Memory (RAM), a Flash memory or other solid state memory, or a hard disk, or be a combination thereof. The processor circuitry 41 may also be configured to store data in the storage 42, as needed. The processing device 4 also comprises a communication interface 43 for communicating with other parts of the WFM system 1 and/or with nodes external to the WFM system.

According to an aspect of the present disclosure, there is provided a processing device 4 for a WFM system 1 for predicting timely completion of a work order 20 for service at a remote site 3 of a telecommunication system 2. The processing device comprises processor circuitry 41, and storage 42 storing instructions 51 executable by said processor circuitry whereby said processing device is operative to obtain information about a time period TP allowed for completion of the work order. The processing device is also operative to select, based on previous knowledge about the remote site 3, a set of factors 32 which may affect service at the remote site. The processing device is also operative to update information about the selected factors. The processing device is also operative to, at a first point in time T1 within the allowed time period, obtain information about a current status 31 of the work order. The processing device is also operative to, based on the updated information and the work order status at said first point of time, predict whether it is likely that the work order will be completed within the allowed time period. The processing device is also operative to, at a second point in time T2 within the allowed time period, obtain information about a current status 31 of the work order. The processing device is also operative to, based on the work order status at said second point of time, predict that it is not likely that the work order will be completed within the allowed time period TP. The processing device is also operative to output a warning for/to an operator 6 of the WFM system that the work order will likely not be completed within the allowed time period unless an additional action is taken.

FIG. 4b is a schematic block diagram functionally illustrating an embodiment of the processing device 4 in FIG. 4a. As previously mentioned, the processor circuitry 41 may run software 51 for enabling the processing device 4 to perform an embodiment of a method of the present disclosure, whereby functional modules may be formed in processing device 4 e.g. in the processor circuitry 41 for performing the different steps of the method. These modules are schematically illustrated as blocks within the processing device 4. Thus, the processing device 4 comprises an obtaining module 44 (e.g. comprised in the communication interface 43) for obtaining information about a time period TP allowed for completion of the work order 20. The processing device also comprises a selecting module 45 for selecting, based on previous knowledge about the remote site 3, a set of factors 32 which may affect service at the remote site. The processing device also comprises an updating module 46 for updating information about the selected factors. The obtaining module 44 may also be for, at a first point in time T1 within the allowed time period, obtaining information about a current status 31 of the work order 20. The processing device also comprises a predicting module 47 for, based on the updated information and the work order status at said first point of time T1, predicting whether it is likely that the work order 20 will be completed within the allowed time period TP. The obtaining module 44 may also be for, at a second point in time T2 within the allowed time period TP, obtaining information about a current status 31 of the work order 20. The predicting module 47 may also be for, based on the work order status 31 at said second point of time T2, predicting that it is not likely that the work order will be completed within the allowed time period TP. The processing device also comprises an outputting module 48 for outputting a warning for/to an operator 6 of the WFM system 1 that the work order 20 will likely not be completed within the allowed time period TP unless an additional action is taken. Alternatively, the modules 44-48 may be formed by hardware, or by a combination of software and hardware.

Thus, according to an aspect of the present disclosure, there is provided a processing device 4 for a WFM system 1 for predicting timely completion of a work order 20 for service at a remote site 3 of a telecommunication system 2. The processing device comprises means 44 for obtaining information about a time period TP allowed for completion of the work order. The processing device also comprises means 45 for selecting, based on previous knowledge about the remote site 3, a set of factors 32 which may affect service at the remote site. The processing device also comprises means 46 for updating information about the selected factors. The processing device also comprises means 44 for, at a first point in time T1 within the allowed time period, obtaining information about a current status 31 of the work order. The processing device also comprises means 47 for, based on the updated information and the work order status at said first point of time, predicting whether it is likely that the work order will be completed within the allowed time period. The processing device also comprises means 44 for, at a second point in time T2 within the allowed time period, obtaining information about a current status 31 of the work order. The processing device also comprises means 47 for, based on the work order status at said second point of time, predicting that it is not likely that the work order will be completed within the allowed time period. The processing device also comprises means 48 for outputting a warning for/to an operator 6 of the WFM system that the work order will likely not be completed within the allowed time period unless an additional action is taken.

FIG. 5 illustrates an embodiment of a computer program product 50. The computer program product 50 comprises a computer readable (e.g. non-volatile and/or non-transitory) medium 52 comprising software/computer program 51 in the form of computer-executable components. The computer program 51 may be configured to cause a processing device 4, e.g. as discussed herein, to perform an embodiment of the method of the present disclosure. The computer program may be run on the processor circuitry 41 of the device 4 for causing it to perform the method. The computer program product 50 may e.g. be comprised in a storage unit or memory 42 comprised in the device 4 and associated with the processor circuitry 41. Alternatively, the computer program product 50 may be, or be part of, a separate, e.g. mobile, storage means/medium, such as a computer readable disc, e.g. CD or DVD or hard disc/drive, or a solid state storage medium, e.g. a RAM or Flash memory. Further examples of the storage medium can include, but are not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Embodiments of the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

According to an aspect of the present disclosure, there is provided a computer program product 50 comprising computer-executable components 51 for causing a processing device 4 to perform an embodiment of the method of the present disclosure when the computer-executable components are run on processor circuitry 41 comprised in the processing device.

According to another aspect of the present disclosure, there is provided a computer program 51 for predicting timely completion of a work order 20 for service at a remote site 3 of a telecommunication system 2. The computer program comprises computer program code which is able to, when run on processor circuitry 41 of a processing device 4 of a WFM system 1, cause the processing device to obtain information about a time period TP allowed for completion of the work order. The code is also able to cause the processing device to select, based on previous knowledge about the remote site, a set of factors 32 which may affect service at the remote site. The code is also able to cause the processing device to update information about the selected factors. The code is also able to cause the processing device to, at a first point in time T1 within the allowed time period, obtain information about a current status 31 of the work order. The code is also able to cause the processing device to, based on the updated information and the work order status at said first point of time, predict whether it is likely that the work order will be completed within the allowed time period, The code is also able to cause the processing device to, at a second point in time T2 within the allowed time period, obtain information about a current status of the work order. The code is also able to cause the processing device to, based on the work order status at said second point of time, predict that it is not likely that the work order will be completed within the allowed time period. The code is also able to cause the processing device to output a warning for an operator 6 of the WFM system that the work order will likely not be completed within the allowed time period unless an additional action is taken.

According to another aspect of the present disclosure, there is provided a computer program product 50 comprising an embodiment of the computer program 51 of the present disclosure and a computer readable means 52 on which the computer program is stored.

FIG. 6 is a flow chart of an embodiment of a method of the present disclosure. The method is performed by a processing device 4 of a WFM system 1 for predicting timely completion of a work order 20 for service at a remote site 3 of a telecommunication system 2. The method comprises obtaining S1 information about a time period TP allowed for completion of the work order. The method also comprises selecting S2, based on previous knowledge about the remote site 3, a set of factors 32 which may affect service at the remote site. The method also comprises updating S3 information about the selected S2 factors. The method also comprises, at a first point in time T1 within the allowed time period, obtaining S4 information about a current status 31 of the work order. The method also comprises, based on the updated S3 information and the work order status at said first point of time, predicting S5 whether it is likely that the work order will be completed within the allowed time period. The method also comprises, at a second point in time T2 within the allowed time period, obtaining S6 information about a current status 31 of the work order. The method also comprises, based on the work order status at said second point of time, predicting S7 that it is not likely that the work order will be completed within the allowed time period TP. The method also comprises outputting S8 a warning for/to an operator 6 of the WFM system that the work order will likely not be completed within the allowed time period unless an additional action is taken.

In some embodiments of the present disclosure, the selecting S2 comprises including factors 32 in the set of factors based on previous knowledge in the form of information stored in the WFM system 1 about how said factors, each or in combination, affect service of the remote site 3 over time. For example, it may be known that the site 3 is closed certain times, or is difficult to reach during certain times due to traffic or bad roads, or the site requires service engineers having certain skills.

In some embodiments, the set of factors 32 comprises WFM system internal factors, e.g. any of attributes of a service engineer 5 who has been assigned the work order 20, attributes of the remote site 3, or availability of spare parts. In some embodiments, the attributes of the remote site 3 comprise any of access restrictions, service logs, equipment in use such as age or type thereof.

In some embodiments, the set of factors 32 comprise WFM system external factors 7 such as any of current weather at the remote site 3, and attributes of a way of travel to the remote site, e.g. state of a road to the remote site or risk of queues.

In some embodiments of the present disclosure, the second point in time T2 is at most an hour after the first point in time T1, e.g. at most half an hour or at most a quarter of an hour. Depending on the duration of the allowed time period TM and the priority of the work order, the periodicity (i.e. the duration between T1 and T2 and further points in time for updating the factor information) may vary.

In some embodiments of the present disclosure, the factors 32 comprised in the set of factors are dynamically reselected within the allowed time period TP, and the predicting S7 based on the work order status at said second point of time T2 is based on information about the reselected factors. Thus, the factors used in the set may vary over time. For instance, if it starts to rain during the allowed time period TP, the weather factor may become relevant for successfully completing the work order in time. Then the weather factor may be included in the set of factors. Possibly, another (deemed less relevant) factor may be removed to not increase the complexity of the method.

The present disclosure has mainly been described above with reference to a few embodiments. However, as is readily appreciated by a person skilled in the art, other embodiments than the ones disclosed above are equally possible within the scope of the present disclosure, as defined by the appended claims.

1-11. (canceled)

12. A method performed by a processing device of a work force management (WFM) system for predicting timely completion of a work order for service at a remote site of a telecommunication system, the method comprising:
obtaining information about a time period allowed for completion of the work order;
selecting, based on previous knowledge about the remote site, a set of factors which may affect service at the remote site;
updating information about the selected factors;
at a first point in time within the allowed time period, obtaining information about a current status of the work order;
based on the updated information and the work order status at said first point of time, predicting whether it is likely that the work order will be completed within the allowed time period;
at a second point in time within the allowed time period, obtaining information about a current status of the work order;
based on the work order status at said second point of time, predicting that it is not likely that the work order will be completed within the allowed time period; and
outputting a warning for an operator of the WFM system that the work order will likely not be completed within the allowed time period unless an additional action is taken.

13. The method of claim 12, wherein the selecting comprises including factors in the set of factors based on previous knowledge in the form of information stored in the WFM system about how said factors, each or in combination, affect service of the remote site over time.

14. The method of claim 12, wherein the set of factors comprises WFM system internal factors.

15. The method of claim 14, wherein the internal factors comprise any of attributes of a service engineer who has been assigned the work order, attributes of the remote site, or availability of spare parts.

16. The method of claim 15, wherein the attributes of the remote site comprise any of access restrictions, service logs, equipment in use such as age or type thereof.

17. The method of claim 12, wherein the set of factors comprise WFM system external factors.

18. The method of claim 17, wherein the external factors comprise any of current weather at the remote site, and attributes of a way of travel to the remote site.

19. The method of claim 12, wherein the second point in time is at most an hour after the first point in time.

20. The method of claim 12, wherein the factors comprised in the set of factors are dynamically reselected within the allowed time period, and wherein the predicting based on the work order status at said second point of time is also based on information about the reselected factors.

21. A computer program product comprising a non-transitory computer readable medium storing computer-executable components for causing a processing device to perform the method of claim 12 when the computer-executable components are run on processor circuitry comprised in the processing device.

22. A processing device for a work force management (WFM) system for predicting timely completion of a work order for service at a remote site of a telecommunication system, the processing device comprising:
processor circuitry; and
storage storing instructions executable by said processor circuitry wherein said processing device is operative to:
obtain information about a time period allowed for completion of the work order;
select, based on previous knowledge about the remote site, a set of factors which may affect service at the remote site;
update information about the selected factors;
at a first point in time within the allowed time period, obtain information about a current status of the work order;
based on the updated information and the work order status at said first point of time, predict whether it is likely that the work order will be completed within the allowed time period;
at a second point in time within the allowed time period, obtain information about a current status of the work order;
based on the work order status at said second point of time, predict that it is not likely that the work order will be completed within the allowed time period; and
output a warning for an operator of the WFM system that the work order will likely not be completed within the allowed time period unless an additional action is taken.

23. A computer program product comprising a non-transitory computer readable medium storing a computer program for predicting timely completion of a work order for service at a remote site of a telecommunication system, the computer program comprising computer program code which is able to, when run on processor circuitry of a processing device of a work force management (WFM) system, cause the processing device to:
obtain information about a time period allowed for completion of the work order;
select, based on previous knowledge about the remote site, a set of factors which may affect service at the remote site;
update information about the selected factors;
at a first point in time within the allowed time period, obtain information about a current status of the work order;
based on the updated information and the work order status at said first point of time, predict whether it is likely that the work order will be completed within the allowed time period;
at a second point in time within the allowed time period, obtain information about a current status of the work order;
based on the work order status at said second point of time, predict that it is not likely that the work order will be completed within the allowed time period; and
output a warning for an operator of the WFM system that the work order will likely not be completed within the allowed time period unless an additional action is taken.
